(19) United States
(12) Patent Application Publication
(10) Pub. No.: US 2008/0051136 A1
(43) Pub. Date: Feb. 28, 2008

(54) METHOD TERMINAL AND METHOD FOR REPRODUCING BUTTON SOUND THEREOF

(76) Inventors: Dae-Ho MOON, Seoul (KR); Kyoung-Wook Park, Gwangmyeong (KR)

Correspondence Address: BIRCH STEWART KOLASCH & BIRCH, PO BOX 747, FALLS CHURCH, VA, 22040-0747, US

(21) Appl. No.: 11/842,725

(22) Filed: Aug. 21, 2007

(30) Foreign Application Priority Data
Aug. 22, 2006 (KR) 10-2006-0079590
Sep. 27, 2006 (KR) 10-2006-0094425

(51) Int. Cl. H04M 1/00

(52) U.S. Cl. 455/556.1

(57) ABSTRACT

A mobile terminal for reproducing music contents according to a keypad input and a method for reproducing a button sound of the mobile terminal are discussed. According to an embodiment, the mobile terminal includes: an input unit including one or more buttons; a memory that stores music contents corresponding to the buttons; a controller that sequentially reproduces the stored music contents by a sound at a time according to a manipulation of the buttons; and a sound output unit that outputs the reproduced music contents under the control of the controller. Music contents desired by a user can be set as a button sound and various button sounds are provided according to pressing of buttons.

This Non-provisional Application claims priority under 35 U.S.C. §119(a) on Patent Application No. 10-2006-0079590 filed in Republic of Korea on Aug. 22, 2006 and No. 10-2006-0094425 filed in Republic of Korea on Sep. 27, 2006, the entire contents of which are hereby incorporated by reference.

### BACKGROUND OF THE INVENTION

1. Field of the Invention

The present invention relates to a mobile terminal for reproducing matched music contents according to input of buttons and a method for reproducing a button sound of the mobile terminal.

2. Description of the Related Art

A mobile terminal is a mobile device that has one or more functions such as voice and video call communication and data input/output and storage, etc. As the mobile terminal has increasingly diverse functions, it is evolving into a multimedia device having multimedia functions such as capturing an image or video, reproducing music and video, playing games or receiving broadcasts.

In order to provide the mobile terminal providing such diverse functions, various modifications have been proposed for the hardware or software. For example, a user interface environment allowing a user to easily and conveniently search or select a function is provided.

In addition, as the mobile terminal is considered as a personal item that may express the user's personality, users are demanding various sound effects or bell sounds as well as various designs.

The sound effects are melodies generated when the mobile terminal is opened or closed, when a menu is shifted or when a key is manipulated, for which melodies in the form of an electronic sound or monophony are designated.

### SUMMARY OF THE INVENTION

Therefore, in order to address the above matters the various features described herein have been conceived. An aspect of the exemplary embodiments is to provide a mobile terminal that is capable of reproducing desired music contents according to a button input and a method for reproducing a button sound thereof.

A mobile terminal according to an embodiment of the present invention may include: an input unit including one or more buttons; a memory that stores music contents corresponding to the buttons; a controller that sequentially reproduces the stored music contents by a sound at a time according to manipulation of the buttons; and a sound output unit that outputs the reproduced music contents under the control of the controller.

The controller may reproduce the music contents as background music while the input unit is being manipulated.

The contents may include a monophony melody, a polyphony melody and a voice.

A method for reproducing a button sound of a mobile terminal according to an embodiment of the present invention may include: setting one or more music contents as button sounds; and sequentially reproducing the set music contents by a sound at a time according to a user's button manipulation.

The button sound may be set with music contents which are different by application.

The music contents may be reproduced in the form of background music while a button is being inputted.

According to another aspect, the present invention provides a mobile terminal comprising: an input unit including one or more selectable items; a memory that stores music contents corresponding to the selectable items; a controller that sequentially reproduces the stored music contents by a sound at a time according to a manipulation of the selectable items; and a sound output unit that outputs the reproduced music contents under the control of the controller.

According to another aspect, the present invention provides a method for controlling a sound of a mobile terminal, comprising: setting one or more music contents as sounds for selectable items of an input unit of the mobile terminal; and sequentially reproducing the set music contents by a sound at a time according to a user's manipulation of the input unit.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a schematic block diagram of a mobile terminal according to an exemplary embodiment of the present invention;

FIG. 2 is a front perspective view of an example of the mobile terminal according to the exemplary embodiment of the present invention; and

FIG. 3 is a flow chart illustrating a method for reproducing a button sound of the mobile terminal according to an embodiment of the present invention.

### DETAILED DESCRIPTION OF THE PREFERRED EMBODIMENTS

The exemplary embodiments of the present invention will now be described with reference to the accompanying drawings.

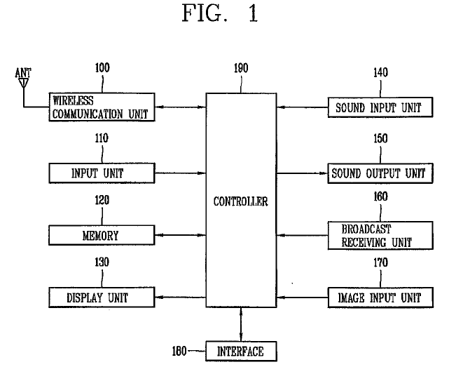

FIG. 1 is a schematic block diagram of a mobile terminal according to an exemplary embodiment of the present invention.

With reference to FIG. 1, the mobile terminal according to the exemplary embodiment of the present invention includes a wireless communication unit 100, an input unit 110, a memory 120, a display unit 130, a sound input unit 140, a sound output unit 150, a broadcast receiving unit 160, an image input unit 170, an interface 180, and a controller 190. The mobile terminal can include other components, and all components of the mobile terminal are operatively coupled and configured. Some examples of the mobile terminal are a mobile phone, a PDA, a computer notebook, a smart phone, a touch-sensitive display device (with or without a key pad) installed in vehicles, etc.

The wireless communication unit 100 includes a transmitting unit that modulates a radio signal and transmits it through an antenna ANT, and a receiving unit that demodulates a received radio signal, where such units can be provided separately or integrally. The radio signal includes an image, a voice, audio, video, text, etc.

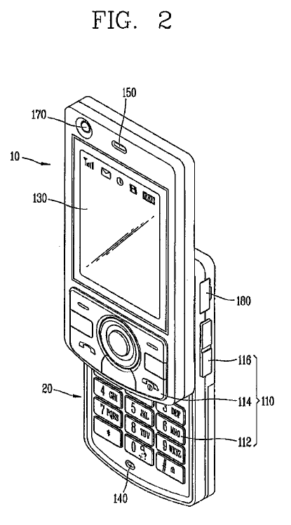

The input unit 110 as shown in FIG. 2 includes a keypad 112 including multiple buttons for inputting numbers, characters, etc., at least one function key 114 allocated to perform at least one certain function, and one or more side key(s) 116. The input unit 110 may be combined with a touch sensor so as to be implemented in the form of a touch pad or touch-sensitive display. The input unit 110 may be implemented by software by using a touch screen (e.g., display unit 130 or other display) combining a touch panel and the display unit 130. In other words, when a button is displayed in the form of an image or an icon on the touch screen, a user may touch a desired button to input a command and data.

The memory or storage unit 120 stores general program(s) required for operations of the mobile terminal and various data generated when the operations are performed. The memory 120 stores contents such as set information related to functions, music, video, games, etc. In the present invention, the music contents are used as a button sound that is generated whenever buttons are manipulated. In addition, some melodies of the music contents may be designated as a button sound.

The mobile terminal according to the present invention may be directly connected with a Web site of a service provider to download the contents or may download contents previously stored in an external device such as a personal computer through data communication. The music contents include melodies or voices in the form of monophony or polyphony, or songs or tunes or part thereof, etc.

The display unit 130 may display information such as images, video, animation, text, etc. under the control of the controller 190. In addition, the display unit 130 displays a state or an operation according to function(s) of the mobile terminal being performed. As described above, the display unit 130 can be used not only as a display unit by being combined with the touch panel for sensing the user's touch and outputting information on the corresponding position, but also as an input unit. The display unit 130 may include one or more display screens such as LCD screens, OLED screens, etc. Such display screens can be provided at various locations on the body or bodies of the mobile terminal.

The sound input unit 140 receives a signal such as a voice signal or other audio signal from the exterior and converts it into an electrical signal. The converted signal is outputted to the wireless communication unit 100 in case of call communication, and is outputted to the memory 120 in case of recording.

The sound output unit 150 converts the voice or other audio data received from the wireless communication unit 100 or other voice or audio data stored in the memory into an audible frequency, and outputs it under the control of the controller 190. In addition, the sound output unit 150 outputs sound effects, namely, a button sound, generated according to function(s) of the mobile terminal being performed and the manipulation of the button(s) of the input unit 110 under the control of the controller 190 for user recognition.

The broadcast receiving unit 160 receives a broadcast signal transmitted from a broadcast signal transmitted from a broadcast station and broadcast related information such as an EPG (Electric Program Guide), etc. The broadcast signal received through the broadcast receiving unit 160 is signal-processed and then outputted to the display unit 130 and the sound output unit 150 under the control of the controller 190.

The image input unit 170 signal-processes image information obtained through an image sensor and transmits it to the display unit 130. In addition, the image input unit 170 stores the obtained image information in the memory 120 under the control of the controller 190.

The interface 180 performs interfacing to allow an external device such as a SIM card, an SD card, a wired/wireless headset, etc., and the mobile terminal to interact with each other. For example, when the contents stored in the PC are downloaded, the user connects the PC and the interface 180 of the mobile terminal through a USB data communication cable and downloads the contents stored in the PC to the mobile terminal through a certain application program. In another example, contents can be downloaded from a server or website via a network to the mobile terminal.

The controller 190 controls general operations of the mobile terminal and controls operations of each element. In addition, the controller 190 stores button sound set information which is set according to a menu operation by the user. The set information includes one or more music contents set as a button sound, a reproducing order, a reproducing time point, and/or a reproducing method, etc.

For instance, when the user presses a button of the input unit 110, the controller 190 reads corresponding music contents from the memory 120 and reproduces the contents (e.g., as a sound generated when the button is pressed) based on the set information.

One or more music contents can be set as the button sound, and in this case, the controller 190 reproduces the music contents according to a certain order or randomly. Here, the certain order may be designated by the user. Alternatively, if the music contents already have determined priority levels, respectively, the music contents can be reproduced according to each priority level.

In the examples of the present invention, the music contents can be set such that they start to be reproduced at various time points, e.g., at a time point when a particular button is inputted/selected, at a time point when setting of the button sound is completed, or at a time point at which an application is executed.

For instance, when the music contents are set to start to reproduce according to a manipulation of a particular button of the mobile terminal, the controller 190 sequentially reproduces a melody of the music contents one by one according to the inputting/selecting of the button, starting from a time point at which the designated button is inputted. Here, the particular button can be a button defined to perform a function that indicates a start of a button sound reproduction.

In another example, when the music contents are set to start to reproduce at a time point at which setting of the button sound is completed, the controller 190 reproduces a pre-set melody one by one no matter which button among the buttons of the input unit 110 is inputted after the button sound is set.

In another example, when the music contents are set to be reproduced from a time point of execution of application, the controller 190 reproduces a pre-set melody of the music contents one by one according to the inputting of a button, starting from a time point at which the application set for the button sound is executed.

In other words, when the music contents are set such that the music contents start to be reproduced at the time point at which characters are inputted to create a text message or others, the pre-set melody of the music contents is reproduced one by one instantly when the user starts to manipulate the buttons of the input unit 110 to input the characters.

For example, in Korea, characters that can be transmitted at one time for a text message transmission are limited to 80 bytes (40 letters), so in order to input the characters of 80 bytes, the buttons need to be inputted (pressed) about a hundred times on average. In this case, in the related art, irregular musical scales or monotones are generated when buttons are inputted, but in the present invention, because the user-desired music contents are reproduced as the buttons are pressed (inputted), the user will likely be entertained at the same time and it will make the text messaging more fun. For instance, the user can pleasantly listen to his desired music or sounds while inputting a text message, which is enjoyable.

FIG. 2 is an example of a front perspective view of the mobile terminal according to the exemplary embodiment of the present invention. In the exemplary embodiment of the present invention, a slide type mobile terminal is taken only as an example and the mobile terminal can be of any other shape, type (e.g., flip type), color, size, etc.

As shown in FIG. 2, the mobile terminal according to the present invention includes a first body 10 and a second body 20 formed to be slidably moved along at least one direction with respect to the first body 10.

The first body 10 includes a function key 114, a display unit 130, a sound output unit 150, and an image input unit 170.

The function key 114 may be manipulated by an operation such as a user's pressing or touch, and receives an execution command of functions such as starting of a call, ending of a call, canceling of a menu, etc.

The display unit 130 can be implemented as a liquid crystal display (LCD) or organic light emitting diodes (OLEDs), etc. that visually display(s) information, or a touch screen that is able to input data by a user's touch. The OLED is commonly used for a display of a small device such as a mobile phone, a car audio set or a digital camera.

The sound output unit 150 may be implemented in the form of a receiver or a speaker. The image input unit 170 may be implemented in the form of a camera module for capturing an image.

The second body 20 may include a keypad 112, side key(s) 116, 180, a sound input unit 140, and an interface 180.

The keypad 112, the function key 114 and the side key 116 may be generally called the input unit 110. The input unit 110 can be implemented as a dome switch, a touch screen or a touch panel that may receive a command or information according to the user's pressing or touch manipulation, or may be implemented as a wheel or a jog for rotating keys or as a jog stick, or a combination thereof.

The keypad 112 can be used for inputting numbers, characters or symbols, and the side key 116, when disposed at the side of the mobile terminal, can be used as a hot key for simply executing an application such as an MP3 player, etc.

The sound input unit 140, which receives a voice of the user or a sound generated from outside, may be implemented as a microphone.

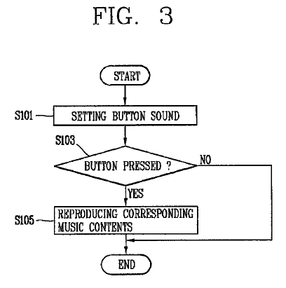

FIG. 3 is a flow chart illustrating a method for reproducing a button sound of the mobile terminal according to the exemplary embodiment of the present invention. This method is discussed as being implemented by the mobile terminal of FIGS. 1 and/or 2, but can be implemented in other device.

When the user selects a button sound setting menu, among menus provided by the mobile terminal, in order to change a button sound, the controller 190 controls the display unit 130 to display a button sound setting screen image. When the user selects desired music contents as a button sound by manipulating the input unit 110 on the setting screen image and presses an OK (confirmation) key, the controller 190 stores the set information related to the button sound in the memory 120 (S101). The set information includes music contents set as the button sound, a reproducing order, a reproducing method, and/or a reproducing time point, etc.

The button sound can be set as one or more music contents, and music contents that are different by application such as a text message a memo, a schedule, a phone book, etc. For example, the contents ‘A’ can be set for a text message menu and contents ‘B’ can be set for a memo menu.

In addition, in the present invention, music contents that are different for each name or phone number registered in the phone book can be set as a button sound. For example, when the contents ‘A’ and contents ‘B’ are set for receivers (other users or terminals) ‘A’ and ‘B’, the contents ‘A’ are reproduced when a button for creating a text message to be transmitted to the receiver ‘A’ is inputted, and when a button for creating a text message to be transmitted to the receiver ‘B’ is inputted, the contents ‘B’ are reproduced.

When the input unit 110 (e.g., buttons, menu items on the display screen, keys, etc.) is manipulated by the user in a state that the button sound (inputting sound) is set as in step S101, the controller 190 checks the set information stored in the memory 120 (S103).

Sequentially, the controller 190 reads the corresponding music contents from the memory 120 according to a button input of the input unit 110 based on the set information and reproduces the read music contents while the user selects the button(s) or performs other functions that have been set to generate the button sounds (S105). The sound output unit 150 converts the reproduced music contents into an audible frequency that can be recognized by the user and outputs it under the control of the controller 190.

For instance, the controller 190 starts reproducing the music contents when the application is executed, when a particular button of the input unit 110 is pressed, or a button sound set complete time point.

When the button of the input unit 110 is manipulated, the controller 190 may sequentially reproduce the set melody of the music contents one by one or reproduce it as background music.

In addition, in the present invention, the background music and the button sound may be set separately so that when the background music is reproduced, the button sound can be outputted simultaneously according to a button input.

For example, when ‘Twinkle, Twinkle little star’ is set as the button sound in using the text message menu and the user presses the buttons of the input unit 110 one by one in order to create a text message, melodies of the music contents, ‘Do’, ‘Ra’, ‘Sol’, ‘Pa’, ‘Mi’, ‘Rae’, ‘Do’, ‘Do’, ‘Do’, ‘Do’, ‘Rae’, ‘Mi’, ‘Pa’, ‘Sol’, etc., are sequentially reproduced one by one.

Or, when ‘Twinkle, twinkle little star’ is set as a button sound in using the menu for making a call, even if the user inputs a phone number 019-111-2222 of the receiver ‘A’ or a phone number 019-111-2222 of the receiver ‘B’ which are completely different phone numbers, the melodies of the ‘Twinkle, twinkle little star’ are externally outputted when the ten buttons of the input unit 110 are pressed. Other variations are possible.

As so far described, the mobile terminal according to the present invention has such an advantage that one or more button sounds can be set and sequentially reproduced to output various button sounds according to a user's taste or preference.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

What is claimed is:

1. A mobile terminal comprising:
an input unit including one or more selectable items;
a memory that stores music contents corresponding to the selectable items;
a controller that sequentially reproduces the stored music contents by a sound at a time according to a manipulation of the selectable items; and
a sound output unit that outputs the reproduced music contents under the control of the controller.

2. The terminal of claim 1, wherein the controller reproduces the music contents as background music while the input unit is being manipulated.

3. The terminal of claim 1, wherein the music contents are downloaded through a data communication with a Web site or an external device.

4. The terminal of claim 1, wherein the music contents include at least one of a monophony melody, a polyphony melody, and a voice.

5. The terminal of claim 1, wherein the controller reproduces one or more music contents set for at least one function of the terminal according to the manipulation of the input unit.

6. The terminal of claim 5, wherein the at least one function includes at least one of: text messaging, making a call, or using a phone book, memo, a schedule, or an alarm.

7. The method of claim 1, wherein the selectable items are buttons on the terminal or menu items displayed on a screen of the terminal.

8. The terminal of claim 7, wherein when multiple music contents are set as a button sound, the controller reproduces the music contents according to the button input in the determined order or randomly.

9. The terminal of claim 7, wherein the controller reproduces the music contents from a time point when a certain button is inputted, or from a time point when an application is executed.

10. The terminal of claim 1, wherein the controller reproduces the music contents at time point when an arbitrary input is pressed immediately after the setting of the selectable item sound is completed.

11. A method for controlling a sound of a mobile terminal, comprising:
setting one or more music contents as sounds for selectable items of an input unit of the mobile terminal; and
sequentially reproducing the set music contents by a sound at a time according to a user's manipulation of the input unit.

12. The method of claim 11, wherein the music contents are downloaded from a Web site or through a data communication with an external device.

13. The method of claim 11, wherein the music contents include a melody or a voice in the form of monophony or polyphony.

14. The method of claim 11, wherein the selectable items are buttons on the terminal or menu items displayed on a screen of the terminal.

15. The method of claim 11, wherein different music contents are set as sounds for using a text messaging, a memo, a schedule, alarm, or a phone book.

16. The method of claim 11, wherein the music contents are reproduced as background music while the input unit is manipulated.

17. The method of claim 11, wherein the music contents are reproduced at a time point when an application is executed.

18. The method of claim 11, wherein the music contents are reproduced immediately after the setting step is completed.

19. The method of claim 14, wherein the music contents are reproduced when a particular button is pressed.

20. The method of claim 19, wherein the particular button is a button set to perform a role of indicating start of reproducing music contents.
